(19) United States
(12) Patent Application Publication
(10) Pub. No.: US 2008/0102888 A1
(43) Pub. Date: May 1, 2008

(54) Mobile Communications Station

(75) Inventors: Seppo Sellgren, Turku (FI); Tapani Hyvonen, Turku (FI)

Correspondence Address: SCHWEGMAN, LUNDBERG & WOESSNER, P.A., P.O. BOX 2938, MINNEAPOLIS, MN, 55402, US

(73) Assignee: ELCOTEQ SE, Espoo (FI)

(21) Appl. No.: 11/795,420

(22) PCT Filed: Jan. 31, 2006
(86) PCT No.: PCT/FI06/50048

§ 371 Date: Jul. 17, 2007

(30) Foreign Application Priority Data
Jan. 31, 2005 (FI) 20050106

(51) Int. Cl. H04M 1/00

(52) U.S. Cl. 455/556.1; 455/575.3

(57) ABSTRACT

A mobile communications device, preferably a mobile communications device, which is preferably a so-called clamshell type portable communications device, PDA-device (Personal Digital Assistance) or a corresponding portable communications device, the parts (107, 108) of which can be turned 360° around a hinge unit (101) and which is provided with a camera (100). According to the present invention the hinge unit is provided with a camera, the pointing direction of which being changeable by turning the parts (107, 108) in relation to each other for accomplishing four different positions of use.

The present invention relates to communications devices. More precisely the present invention concerns mobile communications devices, which is preferably a so-called clamshell type portable communications device, PDA-device (Personal Digital Assistance) or a corresponding portable communications device, the parts of which can be turned 360° and which is provided with a camera.

In a foldable portable communications device that is equipped with a camera (a “clamshell camera phone” or similar), the camera usually is mounted in one of the parts that are foldable or turnable in relation to each other. Typically the camera is situated:
in the main body part of a “clamshell” phone, the said main body part including typically a keypad unit and the main PCB (Printed Circuit Board),
in the flip part of a “clamshell” phone, the said flip part including typically a display unit and a second PCB,
in the hinge/pivoting point of the two parts, i.e. the main body part and the flip part, of the “clamshell” construction, with possibility of manual adjustment of the camera's viewing direction

All these options give several restrictions in the use of the camera. For instance, placing the camera on opposite side of the flip part having the display unit gives user a possibility of aiming the camera by observing a camera image on the flip part's display screen. However, using such camera for video conferencing or self-portrait is not practical. Similar restrictions apply for the other placements, with exception of the manual adjustment, where user can, and must, turn the camera manually to point in the desired direction, or one has to envision a relatively complex mechanism to automate the pointing direction of the camera to suite the user's needs.

These problems of the prior art foldable communications devices are solved by means of a new and inventive mobile communications device, which is preferably a so called clamshell type portable mobile phone, PDA or a corresponding device, including: a first part having an internal side and an outer side; a second part having an internal side and an outer side; and a hinge unit, which hinge unit is provided with a camera, and by means of which hinge unit the said first and seconds parts are connected with each other such that the said first part and the said second part can be turned to at least one intermediate position, in which neither of the said sides of the said first and second parts is against each other, for example such, that the first part and the second part can be turned 360° in relation to each other by means of the hinge unit, and that the pointing direction of the camera is changeable by turning the hinge unit by means of the first part and the second part without untwisting the same in relation to each other. It is preferred, that orientations of the planes, which pass via the shaft means in the hinge unit, of the first part and the second part are not twistable while turning the first part and the second part in relation to each other.

It is preferred that the pointing direction of the camera is changeable by turning the hinge unit. Then it is possible that turning the hinge unit while essentially maintaining the positions of the first part and the second part can change the pointing direction of the camera.

According to a very preferred embodiment of the present invention, an optical axis of the camera is essentially parallel with a plane that passes via the shaft means in the hinge frame of the double-hinged hinge unit, and that the optical axis of the camera is in an angle of essentially 90° in relation to a centre axis of at least one shaft means in the hinge frame.

The other the essential features of the present invention and advantages that can be achieved by the present invention are disclosed in the following detailed description and in the accompanying set of claims.

The advantages of this kind of placement are that
the camera, which is placed in between the main body part and the flip part of the communication device, can be turned always in desirable way for different usage situations,
the hinge module can be equipped optionally with a light source or flash unit, which can be turned in a desirable way for different usage directions and/or in the direction of the camera,
and the user experiences that the camera points in desired direction without explicit camera adjustment from user's side.

The present invention is described in the following detailed description with reference to the accompanying drawings, in which are presented the mobile phone, whereby

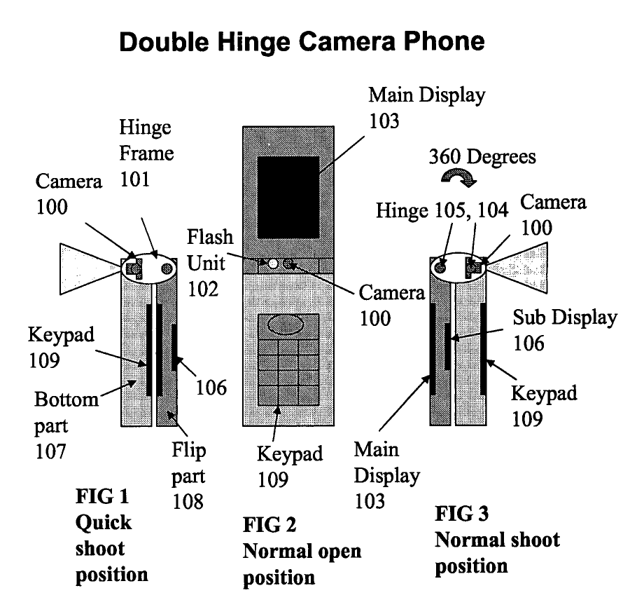

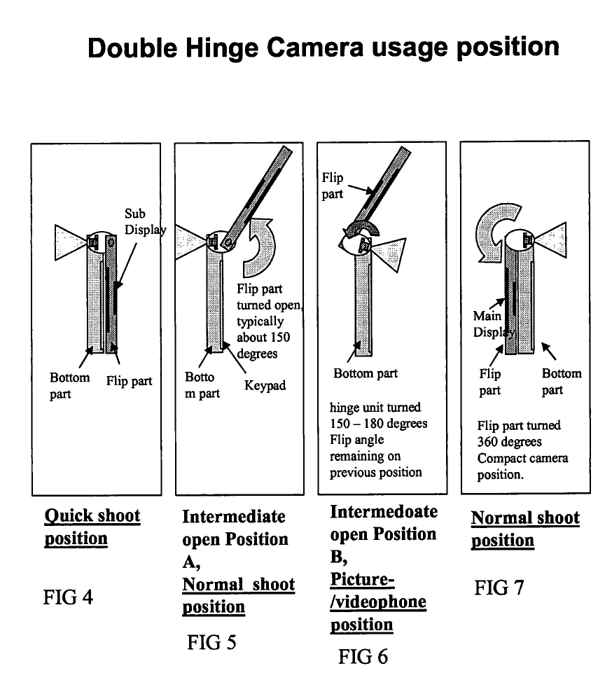

FIG. 1 and FIG. 4 present the camera in a first closed position whereby it is accomplished a quick camera shoot position,

FIG. 5 present the camera in a first open position A, whereby it is accomplished a normal camera phone position as the clamshell phone folded open,

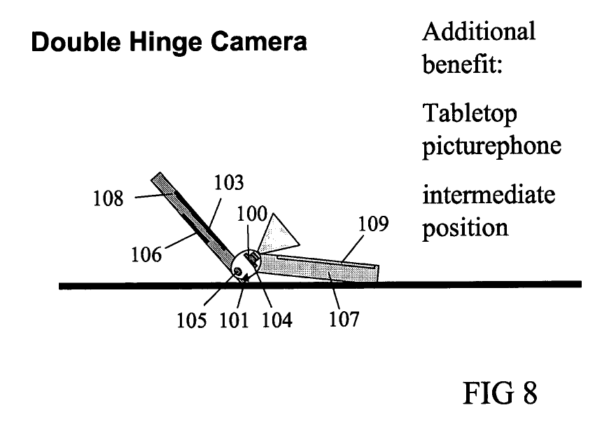

FIG. 2, FIG. 6 and FIG. 8 present the camera in a second open position B, whereby it is accomplished a picture phone/videophone to be used respectively f. ex. as a tabletop picture/video phone with the camera for taking self-portraits or as a tabletop videophone with the camera for utilizing the videophone for video negotiations or conferences, and

FIG. 3 and FIG. 7 present the camera in a second closed position whereby it is accomplished a normal camera shoot position as the phone folded closed,

The mobile communications device according to the present invention that is in the preferred embodiment a so-called clamshell type portable communications device, which includes
a first part 107, which for example a bottom or a main body part, which has an outer or back side and an internal side that is typically provided with a keypad 109;
a second part 108, which is for example a flip part, which has an internal side that is typically provided with a main display 103 and on outer side that can be provided with a sub display 106t: and
a hinge unit, which comprises hinge frame 101 and two shaft means, i.e. the first shaft means 104, which joints to the first part 107, and the second shaft means 105, which joints to the second/part 108, by which shaft means the said first part and the second part are linked with each other such that
   the first part 107 and the second part 108, i.e. the said parts, can be turned in relation to each other 360° from a first extreme position that is a first closed position, in which the said outer sides of the said parts are facing outwards and the said internal sides of the said parts are against each other, to a second extreme position that is a second closed position, in which the said internal sides of the said parts are facing outwards and the said outer sides of the said parts are against each other, and
   the said parts 107, 108 can be turned to at least one intermediate position, in which either of the said internal sides nor outer of the said parts are not against but are apart from each other.

The hinge unit comprising a hinge frame 101 and a first shaft means 104 and second shaft means 105, by means of which hinge unit is achieved the folding functionality of the said parts 107, 108. The hinge unit is provided further with a camera 100. From a point of a picture-/videophone functionality it is preferred that the clamshell camera phone is provided further with a flash unit 102. According to a preferred embodiment of the present invention also the flash unit is arranged to the hinge unit such that it is pointing into the same direction as the camera. In the following there is not described more detailed the flash unit but any skilled in the art may understand that in connection with camera there can be a flash unit or the camera can be utilized without the flash unit.

There is disclosed in fiqures FIG. 4, FIG. 5, FIG. 6 and FIG. 7 the clamshell phone according to the present in four different positions of utilization.

In the figure FIG. 4 as well as in the figure FIG. 1 the said clamshell it is the first closed position, which is a quick shot position, the internals sides of the turning first part 107 and the second part 8 are against each other and the image display 103 is in inside the clamshell phone and the opening of camera 100 points outwards from the backside of the first part 107.

In the figure FIG. 5 the clamshell is in a position, which corresponds a position of a typical clamshell phone and which is therefore typical positions for a clamshell phone with a camera. In the position of figure FIG. 5 the first part 107 and the second part 108 are turned apart from each other to an angle, which is about 150°, and image display 103 as well as the keypad 109 are facing to the user while the camera 100 points as in the position of FIG. 4 points outwards, preferably from the backside of the first part 107.

In the position of figure FIG. 6 as in the figures FIG. 2 and FIG. 8 the jointing hinge unit 101, 104, 105 has been turned and now the clamshell is the position of handheld or tabletop picture-video phone with a camera, whereby both the camera 100 and the keypad 109 and the image display 103 are facing to the user.

In the figure FIG. 7 as well as in the figure FIG. 3 the said clamshell it is the second closed position, which is a normal shot position, the internals sides of the turning first part 107 and the second part 8 are not against each other and are outside the clamshell phone while the opening of camera 100 points outwards from side of the keypad of first part 107.

Reference is made to the figures FIG. 1, FIG. 4 and FIG. 3, FIG. 7. The internal side of the first part 107 of the clamshell phone according to the preferred embodiment comprises typically the keypad 109, and the internal side of second part 108 of the clamshell phone according to the preferred embodiment comprises typically the main image display 103. The sub display 106 is arranged also on the second part but the same is located on the outer side of the said second part. When the clamshell phone is closed, in which position the phone is usually carried if it is not in use, the keyboard and main display are facing to each other.

In the first closed position according to the figures FIG. 1 and FIG. 4, the camera 100 points to opposing direction in relation to the sub display 106 and hence the sub display may function as a viewfinder to utilize the camera.

Whereas the double-hinged hinge unit 101, 104, 105 functions as a link joint, which has two joint axis with a distance there between, the first part 107 and the second part 108 can be turned 360° in relation to each other, i.e. from the first closed position to the second closed position and vice versa. When the clamshell phone is opened rhe camera 100 can be turned selectively to point to opposite directions, which directions are
a quick shoot position according to the figures FIG. 1 and FIG. 4,
a normal shoot position according to the figures FIG. 3 and FIG. 7.

In the second closed position according to the figures FIG. 3 and FIG. 7 the camera 100 points to opposing direction in relation to the main display 103 and hence the main display may function as the viewfinder to utilize the camera.

It is a feature of the present invention that setting of the camera 100 for enabling different camera pointing functions at these extreme closed positions of the clamshell phone according to the figures FIG. 1, FIG. 3 camera pointing direction turns automatically just by turning the first part 107 and the second part 108 in relation to each without any other user intervention.

Between the first closed position and the second closed position there is also at least one open intermediate position.

According to the preferred embodiment of the present invention there are in the order of turning from the first closed position to the second closed position one after another
a first intermediate open position A, which is an intermediate open position A or a normal shoot position, in which the camera 100 points away from the user (figure FIG. 5), and
a second intermediate open position B, which is an intermediate open position B or a picture/videophone position, in which the camera is pointing to the user (figures FIG. 2, FIG. 6 and FIG. 8).

Reference is made to figure FIG. 5, which presents the camera in a first open intermediate position A, whereby it is accomplished a normal shoot position for a camera 100 as the clamshell phone is turned/folded open such that the angle between the internal sides of the first part 107 and the second part 108 is preferably between 120° and 180°, more preferably between 150° and 180° and most preferably typically about 150° degrees.

In this normal or normal open intermediate position A, the keypad 109 and main display 103 are facing the user while the camera 100 points away from the user.

Reference is now made to figures FIG. 2, FIG. 6 and FIG. 8, which present the clamshell camera phone in the second open intermediate position B, whereby it is accomplished a picture/videophone position or in which position the camera phone can be used as a handheld or a tabletop picture/videophone. In this position the angle between the internal sides of the first part 107 and the second part 108 is preferably between 120° and 180°, more preferably between 150° and 180° and most preferably typically about 150° degrees.

In this second intermediate position A, the keypad 109 and main display 103 are facing the user and also the camera 100 is facing to the user.

The turning of the first part 107 and the second part 108 from the first closed position to the second closed position via the first and second intermediate open positions causes an improved serial functionality of the clamshell camera phone according to the present invention as follows.
First either the second part 108 is turned around the second shaft means 105. Naturally same result is achieved by turning the first part 107 around the first shaft means 104. This turning phase is preferably biased or otherwise forced to happen in the direction towards the first intermediate position, in which the camera 100 points away from the user. Preferred is further that this turning phase stops when a proper angle between 120° and 180° is achieved.
Then the hinge frame 101 of the hinge unit is turned around the first shaft means 104 of the bottom part 107, hereby the camera 100 turns to point towards the user and it is provided the second intermediate position, in which the clamshell phone can be used as the handheld picture-/videophone or as the tabletop picture-/videophone. Preferred is that this turning phase is carried out by maintaining the angle between the bottom part 107 and the flip part 108.
Then the second part 108 is turned further around the second shaft means 105, whereby it is achieved the second closed position, in which the keypad 109 side of first part 107 and side of the main display 103 side of the second part 108 are pointing outwards. This turning phase is preferably biased or otherwise forced to happen in the direction from the second intermediate position towards the second position.

The turning feature according to the invention selects automatically the pointing direction of the camera 100. This automatic change of the pointing direction is provided such that the shaft means 104, 105 of either on the first part 107 or on the second part 108 side respectively is stiffer, whereby either the second part or the first part will first turn around the shaft means of hinge unit and in relation to the other clamshell part, when the phone is folded towards the open position. By means of this functionality the camera can be turned automatically to point from one side to the other side of the camera by selection between the first intermediate position and the second intermediate position.

Reference is made to figures FIG. 6 and FIG. 8, in which are presented the camera in a second intermediate open position. Hence it is accomplished a picture-/videophone with camera that can be used as a handheld or as a tabletop picture-/videophone for taking self-portraits or for utilizing the camera of the videophone for example in negotiations or in video conference purposes. In this second open position the camera is typically facing to the user.

If the phone is used as a tabletop picture-/videophone, the backside of the rfirst part 107 is laying against the table surface and the second part is folded/turned to angle in relation to the first part. The angle between the said parts is preferably between 120° and 180°, more preferably between 150° and 180° and most preferably essentially about 150°. In this second open position the camera is facing to the user.

According to a preferred embodiment the turning of the second part 108 and the first part 107 is arranged to take placed firstly around the second shaft means 105 of the two shaft means 104, 105 in the hinge frame 101 for opening the clamshell phone from either of the closed positions towards either of the intermediate positions. Then the hinge unit 101, 104, 105 is turned around the first shaft means 104 from either of the intermediate positions towards the other of the intermediate positions. Finally the turning may take place around the second shaft means 105 of the two shaft means in the hinge frame 101 from the either of the intermediate positions towards either of the other closed positions.

In order to accomplish the desired functionality, the turning of the first part 107 around the first shaft means 104 in the hinge frame 101 is more force demanding than turning of the second part 108 around the second shaft means 105 in the hinge frame. In other words the turning can be more force demanding around the first shaft means 104 that joints the second part 107 to the hinge frame 101. The more demanding turning can be achieved for example such that the shaft means, around which the turning is more force demanding, is biased against tuning or the turning is otherwise prevented.

The invention is described above only by means of one preferred embodiment thereof. It should be evident to any skilled in the art that several variations and modifications as well as equivalent alternatives can be utilised within the scope of the new and inventive idea of the present invention that is defined in the accompanying claims.

Hence it is disclosed further that in any open position of the phone according to the present invention, the flip part can be folded/turned such that the angle, in relation to the main body part, is preferably between essentially 120 and 180 degrees, more preferably between 150 and 180 and most preferably 150 degrees. In this open position the camera can be facing to the user or away from the user. Further additional figures are disclosed in order have any and all skilled in the art to understand the basic functionality of hinge module with camera of the mobile phone according to the present invention.

Further there is a reason to emphasize that in addition to the clamshell type mobile phone, the phone can be composed of a main body part comprising both a main display and keypad while the flip part can be a simple shielding cover part or a part that discloses an additional keypad.

In order to ease the use of the camera the switch therefore can be arranged to the side of either of the first part 107 or second part 108 as is illustrated in the accompanying photocopies of a clamshell phone according to the present invention which photocopies are taken here as illustrating examples. Further can be mentioned that any electricity wirings between the parts 107, 108 may be carried out by a flex means there between and also antenna means is possible to arrange within the hinge means or more conventionally by an antenna means which extends from either of the parts or which is arranged inside either of the parts.

1. A mobile communications device, comprising:
a first part having an internal side and an outer side;
a second part having an internal side and an outer side; and
a hinge unit, which hinge unit is provided with a camera and the hinge unit connects the first and seconds parts with each other such that the first part and the said second part can be turned
360° in relation to each other and
to at least one intermediate position, in which neither of the said sides of the first and second parts is against each other,
wherein the first part and the second part by means of the hinge unit and the pointing direction of the camera is changeable by turning the hinge unit by means of the first part and the second part without untwisting the same in relation to each other such that the mutual orientation of the first part and the second part is maintained.

2. A mobile communications device according to the claim 1, wherein the hinge unit includes a shaft, wherein orientations of the planes, which pass via the shaft in the hinge unit, of the first part and the second part are not twistable while turning the first part and the second part in relation to each other.

3. A mobile communications device according to the claim 1, wherein the hinge unit includes a hinge frame, wherein an optical axis of camera is essentially parallel with a plane that passes via the shaft in the hinge frame of the double-hinged hinge unit, and wherein the optical axis of the camera is in an angle of essentially 90° in relation to a centre axis of at least one shaft in the hinge frame.

4. A mobile communications device according to claim 1 wherein the camera turns from the outer side to the internal side of the first part or the second part of the mobile communications device by turning the hinge unit around one shaft of a two shaft of the hinge unit.

5. A mobile communications device according to claim 4, wherein the second part can be turned around the second shaft of the hinge unit for turning the first part and the second part from the first closed position, which is a normal shoot position, in which the camera points in the direction of the backside the first part, to a first open intermediate position, in which first position the angle between the second part and the first part is between 120° and 180°.

6. A mobile communications device according to the claim 5, wherein the first part and the second part can be turned further from the first open intermediate position to a second open intermediate position by turning the hinge unit around the first shaft, which second intermediate position is a handheld or a tabletop clamshell picture-/video phone the camera and in which the camera is facing to the user while the angle between the second part and the first part is between 120° and 180°.

7. A mobile communications device according to the claim 6, wherein the first part and the second part can be turned further from the second open intermediate position to a second closed position by turning the second part around the second shaft, which second closed position is the normal shoot position, in which the keypad and the main display are pointing outwards while the camera points to the direction of the keypad side of the first part.

8. A mobile communications device according to claim 7, when the mobile communications device is in an intermediate position, the first part and the second part can be transferred in relation to each other, while the same are connected to each other by the hinge unit, such that the planes, which pass via the shaft of the hinge unit, maintain their mutual orientations, whereby the plane of the first part moves over to the other side of the plane of the second half, whereby the pointing direction of the camera is moved over to an opposite direction.

9. A mobile communications device according to claim 4, wherein the second part can be turned around the second shaft means of the hinge unit for turning the first part and the second part from the first closed position, which is a normal shoot position, in which the camera points in the direction of the backside the first part, to a first open intermediate position, in which first position the angle between the second part and the first part is preferably between 150° and 180°.

10. A mobile communications device according to claim 4, wherein the second part can be turned around the second shaft of the hinge unit for turning the first part and the second part from the first closed position, which is a normal shoot position, in which the camera points in the direction of the backside the first part, to a first open intermediate position, in which first position the angle between the second part and the first part is about 150°.

11. A mobile communications device according to the claim 10, wherein the first part and the second part can be turned further from the first open intermediate position to a second open intermediate position by turning the hinge unit around the first shaft, which second intermediate position is a handheld or a tabletop clamshell picture-/video phone the camera and in which the camera is facing to the user while the angle between the second part and the first part is between 120° and 180°.

12. A mobile communications device according to the claim 11, wherein the first part and the second part can be turned further from the first open intermediate position to a second open intermediate position by turning the hinge unit around the first shaft, which second intermediate position is a handheld or a tabletop clamshell picture-/video phone the camera and in which the camera is facing to the user while the angle between the second part and the first part is about 120°.

13. A mobile communications device according to claim 12, wherein the second part can be turned around the second shaft of the hinge unit for turning the first part and the second part from the first closed position, which is a normal shoot position, in which the camera points in the direction of the backside the first part, to a first open intermediate position, in which first position the angle between the second part and the first part is about 150°.

14. A mobile communications device according to the claim 6, wherein the first part and the second part can be turned further from the second open intermediate position to a second closed position by turning the second part around the second shaft, which second closed position is the normal shoot position, in which the keypad and the main display are pointing outwards while the camera points to the direction of the keypad side of the first part.
